(19) United States
(12) Patent Application Publication
(10) Pub. No.: US 2013/0085791 A1
(43) Pub. Date: Apr. 4, 2013

(54) SWITCHING ROUTING ALGORITHMS TO OPTIMIZE SATISFACTION OF LONG-TERM COMMITMENTS

(71) Applicants: Andrew D. Flockhart, Thornton, CO (US); Joylee Kohler, Northglenn, CO (US); Robert C. Steiner, Broomfield, CO (US)

(72) Inventors: Andrew D. Flockhart, Thornton, CO (US); Joylee Kohler, Northglenn, CO (US); Robert C. Steiner, Broomfield, CO (US)

(73) Assignee: AVAYA INC., Basking Ridge, NJ (US)

(21) Appl. No.: 13/250,521

(22) Filed: Sep. 30, 2011

(51) Int. Cl. G06Q 10/06

(52) U.S. Cl. 705/7.13

(57) ABSTRACT

A contact center is described along with various methods and mechanisms for administering the same. The contact center proposed herein provides the ability to, among other things, monitor workload distribution to one or more sub-contractors and predict whether a contractual obligation will be met (or not) and based on such a prediction automatically switch routing algorithms within a contractual period of time to ensure that costs associated with a contract are minimized.

### FIELD OF THE DISCLOSURE

The present disclosure is generally directed toward communications and more specifically toward contact centers.

### BACKGROUND

Many administrators of contact centers (e.g., contractors) have relationships with outsourcers (e.g., sub-contractors). The contractors use sub-contractors to help handle traffic during periods of heavy traffic. The agreement between the contractor and each of their sub-contractors (contractors often have more than one sub-contractor) often defines the long-term (e.g., daily, weekly, monthly, yearly) workload supply and demand commitments that each party will agree to. In particular, the contractor will often guarantee a certain amount of call traffic over a period of time (e.g., guarantee 100,000 contacts in every one month period for two years). Conversely, the sub-contractor will often guarantee that they will meet any demand needs of the contractor over a period of time up to a certain maximum while maintaining a certain level of quality (e.g., guarantee that they can handle up to 100,000 contacts in every one month period while meeting a certain percent service level, percent abandonment, or some other metric of performance).

In the above scenario, the agreement may stipulate that the contractor has to pay for 100,000 contacts even if fewer than this number are delivered to the sub-contractor. Therefore, it is in the contractor's interest to ensure that at least 100,000 contacts are delivered to that specific sub-contractor. The contract may also impose a penalty for every contact exceeding 105,000. For optimal efficiency, the contractor would ideally deliver between 100,000 to 105,000 contacts to their sub-contractor each period over the term of the agreement.

As can be appreciated, there are penalties associated with either side failing to meet their commitments defined in the agreement. Moreover, the contractor often pays the sub-contractor more money per call than it would pay if the call were handled by internal agents. Thus, the contractor is incentivized to meet their agreement minimums with each sub-contractor without greatly exceeding such minimums. This incentive often results in the contractor sending a small number of calls to the sub-contractor in the beginning of a time period, but then sending a larger amount of calls toward the end of time period. Historically speaking, the adjustments made throughout the time period are made manually by the contractor's administrative personnel and there is not a lot of intelligence built into the routing logic to facilitate the adjustments.

It would be desirable to provide a solution which helps both contractors and sub-contractors satisfy their agreements while also minimizing costs, administrative overheads and penalties.

### SUMMARY

It is with respect to the above issues and other problems that the embodiments presented herein were contemplated. This disclosure proposes a solution in the work assignment engine which is capable of analyzing some or all of the long-term commitments that a contractor has, monitoring call/contact distribution to the various sub-contractors over the periods of time defined in each agreement, and routing contacts among internal agents and agents at the various sub-contractors to minimize costs while also meeting as many contractual commitments as possible.

While embodiments of the present disclosure are particularly useful for contractors that have multiple agreements with multiple different sub-contractors, the proposed solution is probably best understood by analyzing a single contractor/sub-contractor commitment. Consider, for example, that a contractor and sub-contractor have a one-year contract which defines that the contractor will provide the sub-contractor with at least 100,000 calls/one month period for 12 months. Also assume that there is a penalty of X times Y, where X equals a monetary penalty and Y equals 100,000 minus the number of calls sent to the outsourcer in a given month (when Y<100,000). The one-year contract may also define that there is a monetary penalty for excess calls above a maximum of 105,000 calls/one month period

Embodiments of the present disclosure can employ a traffic monitor either in the work assignment engine or as a plug-in to the work assignment engine that tracks the number of calls/contacts sent from the contractor to the sub-contractor within a given period of time. The traffic monitor can extrapolate the data related to calls/contacts already sent to the sub-contractor over the entire period of time and predict whether or not the current call routing algorithm will enable the contractor to meet their contractual obligations with the sub-contractor. If some component of the work assignment engine (e.g., the traffic monitor, an optimization agent, etc.) determines that a different call routing algorithm is needed to ensure that the contractor will meet the sub-contractor contract requirements, the work assignment engine (with the help of the traffic monitor) will cause the work assignment engine to switch to the different call routing algorithm.

As discussed herein, the traffic monitor can switch the call routing algorithm to either increase the traffic being sent to the sub-contratcor in a period or decrease the traffic being sent to the sub-contractor. Also, the traffic monitor can be programmed to only allow a certain percentage change in traffic provided to the outsourcer within a certain period of time. This can help eliminate the situation where contractor client tries to send the outsourcer 1,000 calls in the first three weeks of the month and 99,000 calls in the last week of the month.

As can be appreciated, embodiments of the present disclosure can optimize call routing where more complicated penalty equations are used. As an example, embodiments described herein can be configured to handle graduated penalties (e.g., increasing penalties for multiple monthly failures to meet a commitment) for one contractor/sub-contractor agreement or for multiple contractor/sub-contractor agreements, etc.

Embodiments of the present disclosure may be useful for clients as well as contractors because it can help contractors balance their work force to meet the contractual obligations (usually outsourcers work for multiple clients). Thus, if the contractor is going to violate the terms of some contracts, the contractor can be provided with a work assignment engine which employs a call routing algorithm that attempts to minimize their costs for non-compliance with one or more sub-contractor contracts.

Furthermore, embodiments of the present disclosure can be implemented in a traditional queue-based contact center by having a dedicated sub-contractor queue in the contractor's contact center. Embodiments of the present disclosure can also be implemented in the queueless contact center (next generation contact center) in a couple of different ways. One way to implement this solution is to change properties of the resources by marking sub-contractor agents as a special type of agent (e.g., an external resource) and changing their properties to reflect that they are a more expensive agent. In the queueless contact center, the agents from the sub-contractor may also have another data field to signify the sub-contractor's state (e.g., whether the outsourcer is behind or ahead of the service level objectives). All of this data can be used to facilitate the routing decision. Additionally, the properties of each external resource may be continuously adjusted as contacts are routed to the external resource. For example, the cost of an agent (as a property) may be continuously modified to get the desired distribution. Another implementation may manipulate the logic of the algorithm rather than manipulating the properties of the resources.

Embodiments of the present disclosure are not limited to calls, but can be employed for any contact type (e.g., email, text, IM chat, call, video call, etc.)

In accordance with at least some embodiments of the present disclosure, a method is provided which generally comprises:
using, by a work assignment engine, a first routing algorithm to make work item routing decisions in the contact center, the first routing algorithm causing a first ratio of work items to be routed to a second entity that operates additional resources outside the contact center;
assessing an agreement between the first entity and second entity that defines one or more long-term commitments over a commitment period;
estimating, at a first time during the commitment period, a total number of work items that will be routed to the second entity by the end of the commitment period; and
determining, by a cost optimization agent operating on a server in the contact center and based on the estimated total number of work items that will be routed to the second entity by the end of the commitment period, whether to continue using the first routing algorithm or to switch to using a second routing algorithm that causes a second ratio of work items to be routed to the second entity.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine”, “calculate”, and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that individual aspects of the disclosure can be separately claimed.

### BRIEF DESCRIPTION OF THE DRAWINGS

The present disclosure is described in conjunction with the appended figures:

FIG. 1 is a block diagram of a communication system in accordance with embodiments of the present disclosure;

FIG. 2 is a block diagram depicting a data structure used in accordance with embodiments of the present disclosure;

FIG. 3A is a first chart depicting a first predicted work load and the response thereto in accordance with embodiments of the present disclosure;

FIG. 3B is a second chart depicting a second predicted work load and the response thereto in accordance with embodiments of the present disclosure;

FIG. 3C is a third chart depicting a third predicted work load and the response thereto in accordance with embodiments of the present disclosure; and

FIG. 4 is a flow diagram depicting a method of optimizing workloads/costs by adjusting work assignment algorithms in a contact center in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

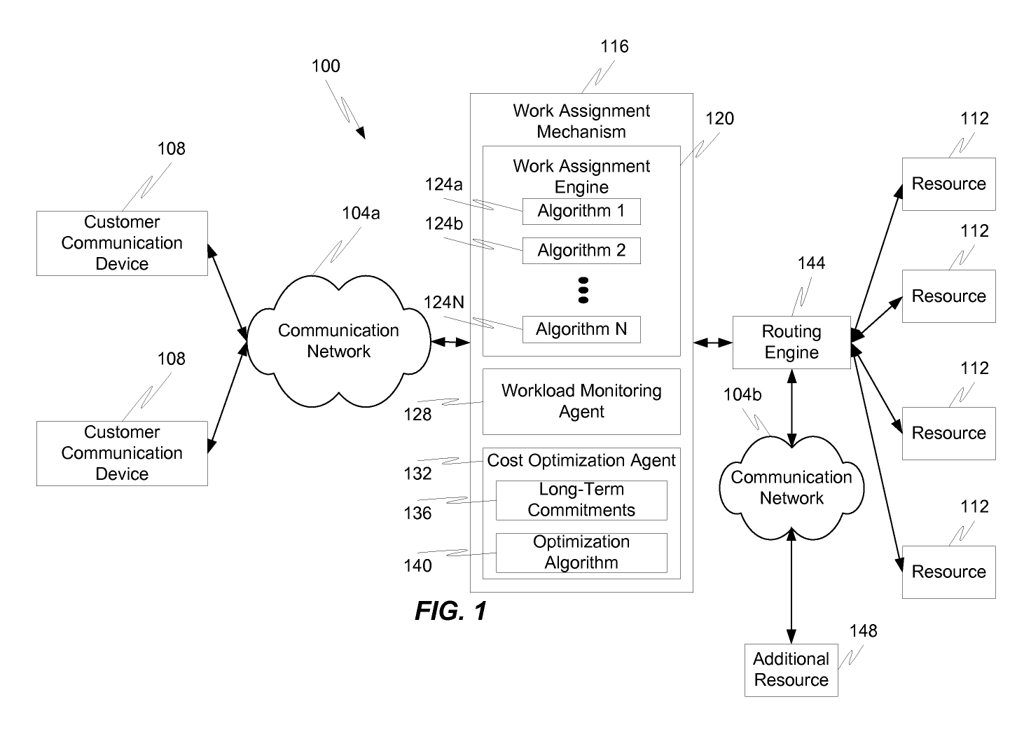

FIG. 1 shows an illustrative embodiment of a communication system 100 in accordance with at least some embodiments of the present disclosure. The communication system 100 may be a distributed system and, in some embodiments, comprises one or more communication networks 104a, 104b. In some embodiments, a first communication network 104a connects one or more communication devices 108 to a work assignment mechanism 116, which may be owned and operated by an enterprise administering a contact center in which a plurality of resources 112 are distributed to handle incoming work items (in the form of contacts) from the customer communication devices 108. A second communication network 104b may connect additional resources 148 to the enterprise administering the contact center. In some embodiments, the additional resources 148 may be similar or identical to the resources 112 except that the additional resources 148 are owned and operated by an entity that is different from the entity which owns and operates the resources 112. The two entities which operate the different resources 112, 148 may be parties to a contractual agreement whereby one of the parties has committed to providing the other party a certain amount of work over a fixed period of time.

For ease of discussion, the entity which controls the work assignment mechanism 116 will be referred to herein as a “contractor” and the entity(ies) which own and operate the additional resources 148 will be referred to herein as “sub-contractors.” It should be appreciated that the contractor may have relationships with a plurality of sub-contractors, each of which may have their own dedicated additional resources 148 and each of which may be separately connected to the contractor via the second communication network 104b, which may actually be a number of different communication networks.

In accordance with at least some embodiments of the present disclosure, one or both of the communication networks 104a, 104b may comprise any type of known communication medium or collection of communication media and may use any type of protocols to transport messages between endpoints. The communication network(s) 104a, 104b may include wired and/or wireless communication technologies. The Internet is an example of the communication network 104a, 104b that constitutes an Internet Protocol (IP) network consisting of many computers, computing networks, and other communication devices located all over the world, which are connected through many telephone systems and other means. Other examples of the communication networks 104a, 104b include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, a cellular network, and any other type of packet-switched or circuit-switched network known in the art. In addition, it can be appreciated that the communication network(s) 104a, 104b need not be limited to any one network type, and instead may be comprised of a number of different networks and/or network types. As one example, embodiments of the present disclosure may be utilized to increase the efficiency of a grid-based contact center. Examples of a grid-based contact center are more fully described in U.S. patent application Ser. No. 12/469,523 to Steiner, the entire contents of which are hereby incorporated herein by reference. Moreover, the communication network(s) 104a, 104b may comprise a number of different communication media such as coaxial cable, copper cable/wire, fiber-optic cable, antennas for transmitting/receiving wireless messages, and combinations thereof. It may also be possible that the networks 104a and 104b are combined into a single communication network 104, which means that the contractor uses the same communication network to communicate with customer communication devices 108 as it uses to communicate with its sub-contractors.

The communication devices 108 may correspond to customer communication devices. In accordance with at least some embodiments of the present disclosure, a customer may utilize their communication device 108 to initiate a work item, which is generally a request for a processing resource 112. Exemplary work items include, but are not limited to, a contact directed toward and received at a contact center, a web page request directed toward and received at a server farm (e.g., collection of servers), a media request, an application request (e.g., a request for application resources location on a remote application server, such as a SIP application server), and the like. The work item may be in the form of a message or collection of messages transmitted over the communication network 104. For example, the work item may be transmitted as a telephone call, a packet or collection of packets (e.g., IP packets transmitted over an IP network), an email message, an Instant Message, an SMS message, a fax, and combinations thereof.

In some embodiments, the communication may not necessarily be directed at the work assignment mechanism 116, but rather may be on some other server in the communication network 104 where it is harvested by the work assignment mechanism 116, which generates a work item for the harvested communication. An example of such a harvested communication includes a social media communication that is harvested by the work assignment mechanism 116 from a social media network or server. Exemplary architectures for harvesting social media communications and generating work items based thereon are described in U.S. patent application Ser. Nos. 12/784,369, 12/706,942, and 12/707,277, filed Mar. 20, 1010, Feb. 17, 2010, and Feb. 17, 2010, respectively, each of which are hereby incorporated herein by reference in their entirety.

The format of the work item may depend upon the capabilities of the communication device 108 and the format of the communication. In particular, work items are logical representations within a contact center of work to be performed in connection with servicing a communication received at the contact center (and more specifically the work assignment mechanism 116). The communication may be received and maintained at the work assignment mechanism 116, a switch or server connected to the work assignment mechanism 116, or the like until a resource 112 or 148 is assigned to the work item representing that communication at which point the work assignment mechanism 116 passes the work item to a routing engine 144 to connect the communication device 108 which initiated the communication with the assigned resource 112 or 148.

Although the routing engine 144 is depicted as being separate from the work assignment mechanism 116, the routing engine 144 may be incorporated into the work assignment mechanism 116 or its functionality may be executed by the work assignment engine 120.

In accordance with at least some embodiments of the present disclosure, the communication devices 108 may comprise any type of known communication equipment or collection of communication equipment. Examples of a suitable communication device 108 include, but are not limited to, a personal computer, laptop, Personal Digital Assistant (PDA), cellular phone, smart phone, telephone, or combinations thereof. In general each communication device 108 may be adapted to support video, audio, text, and/or data communications with other communication devices 108 as well as the processing resources 112, 148. The type of medium used by the communication device 108 to communicate with other communication devices 108 or processing resources 112, 148 may depend upon the communication applications available on the communication device 108.

In accordance with at least some embodiments of the present disclosure, the work item is sent toward a collection of processing resources 112 or 148 via the combined efforts of the work assignment mechanism 116 and routing engine 144. The resources 112, 148 can either be completely automated resources (e.g., Interactive Voice Response (IVR) units, processors, servers, or the like), human resources utilizing communication devices (e.g., human agents utilizing a computer, telephone, laptop, etc.), or any other resource known to be used in contact centers.

As discussed above, the work assignment mechanism 116 and resources 112 may be owned and operated by a common entity in a contact center format. The additional resources 148, however, may be owned and operated by a different entity that acts as a sub-contractor to the entity which owns and operates the work assignment mechanism 116 and/or routing engine 144. In such an embodiment, the additional resources 148 may be co-located with the resources 112 even though they are owned and operated by different entities. In other embodiments, the additional resources 148 may be physically separated from the resources 112. In some specific embodiments, the second communication network 104b may correspond to a trans-oceanic communication network. As an example, the resources 112 may be located in a first country and the additional resources 148 may be located in a different country that is separated from the first country by one or more large bodies of water (e.g., ocean, sea, etc.).

The sub-contractor may actually be more expensive to handle contacts, but is often provided to help handle sudden and unexpected variations in contact center workflow (e.g., successful outbound contacts and/or increased number of inbound contacts). Accordingly, the contractor may be motivated to try and control the amount of workflow that is provided to the sub-contractor (e.g., the number of contacts that are assigned and routed to the additional resources 148 instead of the internal resources 112). This intelligent control over workflow provided to the additional resources 148 may be implemented by the combined efforts of the work assignment mechanism 116 and/or routing engine 144.

In some embodiments, the work assignment mechanism 116 comprises a work assignment engine 120 which enables the work assignment mechanism 116 to make intelligent routing decisions for work items. In some embodiments, the work assignment engine 120 is configured to administer and make work assignment decisions in a queueless contact center, as is described in U.S. patent application Ser. No. 12/882,950, the entire contents of which are hereby incorporated herein by reference. The work assignment engine 120 may also be configured to administer and make work assignment decisions in a traditional queue-based contact center where skill-based routing is used to assign work items to resources 112, 148.

If a queueless contact center is implemented, the work assignment engine 120 can generated bitmaps/tables and determine, based on an analysis of the bitmaps/tables, which of the plurality of processing resources 112, 148 is eligible and/or qualified to receive the work item and further determine which of the plurality of processing resources 112, 148 is best suited to handle the processing needs of the work item. In situations of work item surplus, the work assignment engine 120 can also make the opposite determination (i.e., determine optimal assignment of a work item to a resource).

In some embodiments, the work assignment engine 120 may have the ability to implement a plurality of different routing algorithms 124a-N. Routing algorithms can include the manipulation of the properties of resources 112, 148 and/or the changing of routing logic. Each of the different routing algorithms 124a-N may result in work items being assigned differently among the different resources 112 and 148. As a very simple and non-limiting example, a first routing algorithm 124a may dictate that one out of every twenty work items should be assigned to additional resources 148 of a sub-contractor whereas a second routing algorithm 124b may dictate that one out of every five work items should be assigned to additional resources 148. Different algorithms, in other embodiments, may cause work items to be sent to the additional resources 148 at different rates. Different algorithms, in other embodiments, may cause the properties of the different resources 112, 148 to be altered differently as work items are routed to them. More complicated routing algorithms 124a-N may be implemented such as skill-based routing algorithms, optimization-based routing algorithms (e.g., algorithms which attempt to maximize profit/contact, minimize processing time/contact, minimize customer wait time, minimize cost/contact, etc.). These more complicated routing algorithms 124a-N may consider more than one input in making work item-routing decisions, but in essence each of the different routing algorithms 124a-N may result in a different ratio of work items being assigned to the additional resources 148—which ultimately impacts the costs of operating the contact center.

The work assignment engine 120 may reside in the work assignment mechanism 116 or in a number of different servers or processing devices. In some embodiments, cloud-based computing architectures can be employed whereby one or more components of the work assignment mechanism 116 are made available in a cloud or network such that they can be shared resources among a plurality of different users.

In addition to comprising the work assignment engine 120, the work assignment mechanism 116 may also comprise a workload monitoring agent 128 and a cost optimization agent 132. The workload monitoring agent 128 may be configured to analyze the number of work items that have been sent to a sub-contractor (or a number of different sub-contractors). In particular, the workload monitoring agent 128 may be configured to determine the number of work items that have been sent to a sub-contractor within a subset of a fixed period of time (e.g., within part of a contractual period) and estimate the total number of work items that will be sent to the sub-contractor for the entirety of the fixed period of time (e.g., after the entire fixed period of time has passed). In some embodiments, the workload monitoring agent 128 is configured to predict the number of work items that will be provided to a sub-contractor for a long-term contractual period (e.g., a week, month, quarter, year, etc.). The workload monitoring agent 128, in some embodiments may comprise Artificial Intelligence that is capable of receiving inputs from a number of different data sources and then generating a predicted workload for a specified period of time.

The workload monitoring agent 128 may provide its predictions regarding workload to the cost optimization agent 132. The cost optimization agent 132 may utilize the predictions received from the workload monitoring agent 128 and compare the predictions to the long-term commitments 136 that exist between the contractor and the sub-contractor. The cost optimization agent 132 may also comprise an optimization algorithm 140 which enables the cost optimization agent 132 to determine whether the appropriate routing algorithm 124a-N is currently being used to satisfy the long-term commitments 136 or at least minimize the costs associated with not satisfying the long-term commitments 136. Alternatively, the cost optimization agent 132 may determine from the optimization algorithm 140 that it is more cost-effective to break one or more long-term commitments 136 with one or more sub-contactors because it is cheaper to pay for breaking the long-term commitments 136 and handle some of the work items with internal resources 112.

It should be noted that the workload monitoring agent 128 and/or cost optimization agent 132 do not necessarily need to reside in the work assignment mechanism 116. Rather, one or both of these components 128, 132, or portions thereof, may be implemented in the routing engine 144 or some other separate server or switch that is connected to the work assignment mechanism 116.

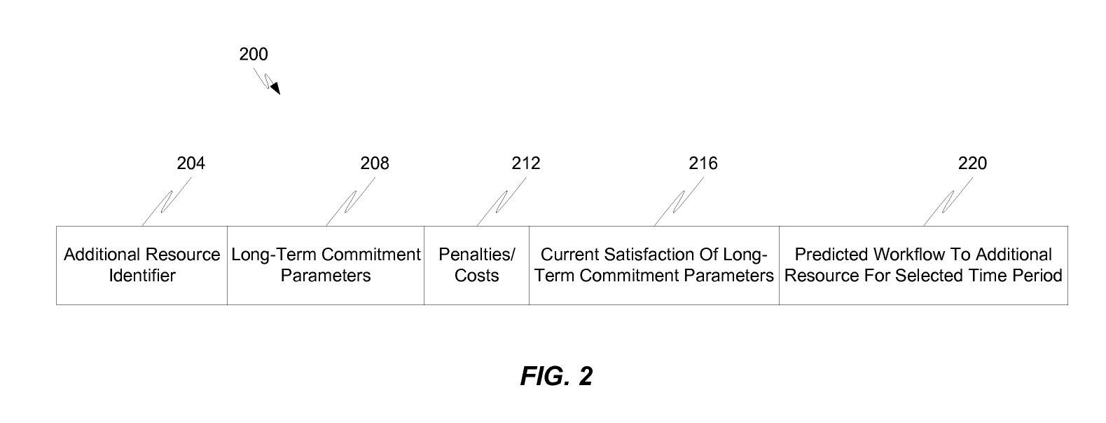

FIG. 2 depicts one example of a data structure 200 which may be generated and used by the various components of the work assignment mechanism 116. In particular, a contact center contractor may use the data structure 200 or multiple similar data structures to help minimize costs associated with long-term commitments between the contractor and one or more sub-contractors. In some embodiments, a single data structure 200 may comprise the data necessary for the contractor to assess its long-term commitments with a plurality of sub-contractors. Alternatively, the contractor may use a different data structure 200 for each of their sub-contractors and the different data structures may be similar but do not necessarily have to have the exact same data fields.

The example data structure 200 depicted comprises a plurality of data fields to help manage long-term commitments between a contractor and sub-contractor. Examples of such data fields include, without limitation, an additional resource identifier field 204, a long-term commitment parameters field 208, a penalties/costs field 212, a current workload satisfaction field 216, and a predicted workload field 220.

The additional resource identifier field 204 may comprise data which describes the sub-contractor. In some embodiments, the additional resource identifier field 204 comprises an identification of the sub-contractor's relationship with the contractor as well as one or more of the sub-contractor's name, address, sub-contractor number, location of additional resources 148, etc.

The long-term commitment parameters field 208 may comprise similar or identical data to the long-term commitments 136 maintained by the cost optimization agent 132. In some embodiments, the long-term commitment parameters field 208 comprises data which describes the measurable parameters that are defined in the agreement between the contractor and sub-contractor and the relevant values for such parameters. As some examples, the long-term commitment parameters field 208 may comprise values for one or more of (i) the entire life of the agreement (e.g., when the agreement is in-force or becomes expired), (ii) commitment periods for the agreement (e.g., the agreement defines that certain commitments must be met on an hourly, daily, weekly, monthly, quarterly, or yearly basis), (iii) commitment measurable (e.g., definition of minimum number of contacts guaranteed by contractor within each commitment period, definition of maximum number of contacts allowed within each commitment period, supply commitments of the sub-contractor for each commitment period, costs associated with non-material breach of the agreement (e.g., defined costs for failing to comply with commitment measurable within a commitment period), (iv) definition of material breach of agreement (e.g., events that will occur in a material breach of the agreement, and (v) rank of importance of the agreement as compared to other agreements between the contractor and other sub-contractors.

The penalties/costs field 212 may comprise data that describes the number of penalties already incurred under the agreement. The data in this field may be cumulative for the life of the agreement or it may be reset every commitment period. Data within the penalties/costs field 212 can help the contractor determine past infractions of the agreement and how such past infractions impact or might impact future infractions of the agreement.

The current workload satisfaction field 216 and predicted workload field 220 may comprise data that is generated by and/or obtained from the workload monitoring agent 128. Specifically, the current workload satisfaction field 216 may comprise data describing the workload (e.g., in terms consistent with the parameters of the agreement) that has already been sent from the contractor to the sub-contractor. This historical data may correspond to all workload already sent during the life of the agreement and/or all workload already sent within the current commitment period.

The predicted workload field 220, on the other hand, may comprise an estimation of the workload that will be sent to the sub-contractor at the end of the commitment period. The data in this field may be determined by extrapolating the data from the current workload satisfaction field 216 across the remainder of the commitment period. Standard variations and predicted changes in workload due to expected events may also be accounted for when predicting the workload that will be provided to the sub-contractor by the end of the commitment period. In some embodiments, the prediction of workload may also be determined based on the routing algorithm 124a-N that is currently being used by the work assignment engine 120. If the routing algorithm 124a-N is switched during a commitment period, then the data in the predicted workload field 220 may be re-calculated to account for the change in the routing behavior of the work assignment engine 120. In some embodiments, the combination of different predictors obtained from different forms of aggregation could be used to derive the “best model” for estimating the future workload.

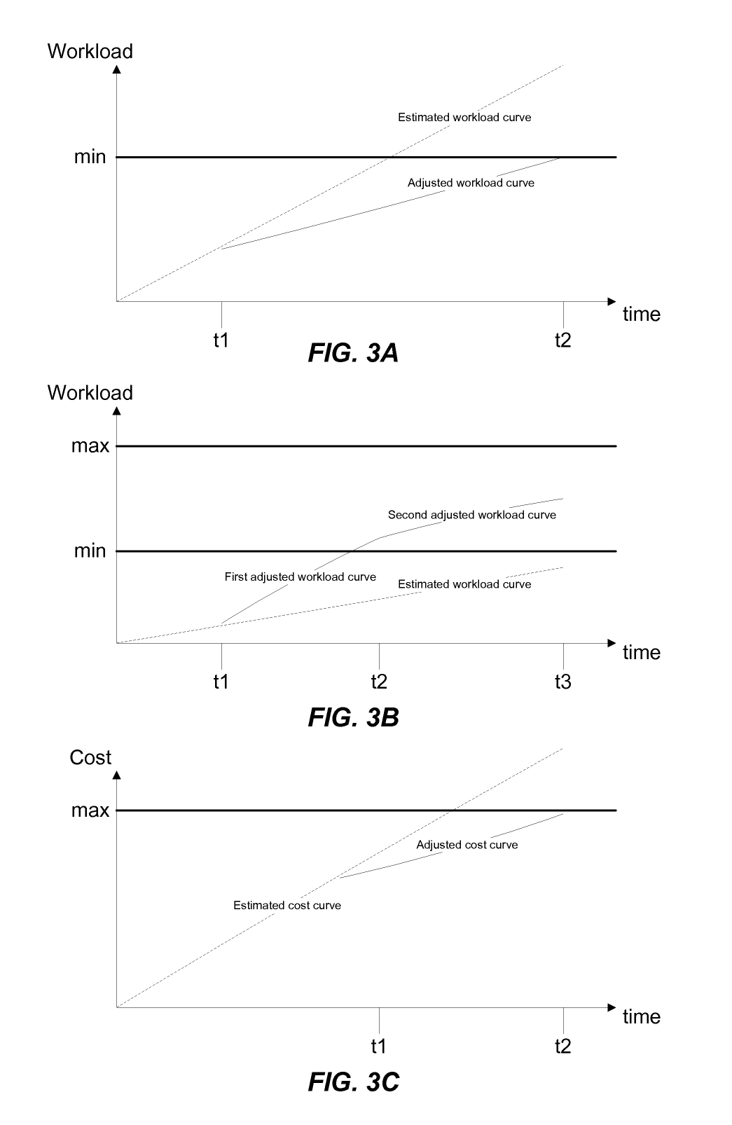

With reference now to FIGS. 3A-C, various graphical representations of the data analyzed and generated by the workload monitoring agent 128 will be described in accordance with embodiments of the present disclosure.

FIG. 3A shows an example where a minimum workload threshold over a commitment period (t2) is defined between a contractor and sub-contractor. At the beginning of the commitment period, no workload (e.g., in the form of contacts) has been sent from the contractor to the sub-contractor. After a first amount of time (t1) has passed (e.g., a first subset of the commitment period), the workload monitoring agent 128 is capable of assessing the workload that has already been provided to the sub-contractor up to the first amount of time (t1). Based on this assessment, the workload monitoring agent 128 is configured to estimate the workload that will be provided to the sub-contractor by the end of the commitment period (t2). Specifically, the workload monitoring agent 128 generates an estimated workload curve and determines that the estimated workload curve exceeds the minimum workload threshold. This estimation information can be provided to the cost optimization agent 132 which uses the optimization algorithm 140 to analyze the costs associated with sending more contacts to the sub-contractor than the minimum. In particular, the cost optimization agent 132 may determine that every contact sent to the sub-contractor (e.g., the additional resources 148) over the minimum threshold results in unnecessary and additional costs. Based on this determination, the cost optimization agent 132 can instruct the work assignment engine 120 to change from a first routing algorithm 124a to a second routing algorithm 124b so as to more closely match workload provided to the sub-contractor at the end of the commitment period (t2) with the minimum workload threshold. By switching routing algorithms, the work assignment mechanism 116 is configured to minimize costs over the commitment period.

FIG. 3B shows an example where minimum and maximum workload thresholds over a commitment period (t3) is defined between a contractor and sub-contractor. At the beginning of the commitment period, no workload has been sent from the contractor to the sub-contractor. After a first amount of time (t1) has passed, the workload monitoring agent 128 is capable of assessing the workload that has already been provided to the sub-contractor up to the first amount of time (t1). Based on this assessment, the workload monitoring agent 128 is configured to estimate the workload that will be provided to the sub-contractor by the end of the commitment period (t3). Specifically, the workload monitoring agent 128 generates a first estimated workload curve and determines that the estimated workload curve will not meet the minimum threshold by the end of the commitment period (t3). The cost optimization agent 132 may analyze this information and determine that failure to meet the minimum threshold by the end of the commitment period (t3) may result in fees or penalties under the long-term commitment agreement between the contractor and sub-contractor. The cost optimization agent 132 may also compare these fees or penalties with costs associated with using the additional resources 148 versus the costs associated with using resources 112 for handling the contacts the difference between the contacts sent to the sub-contractor and the minimum threshold. The optimization algorithm 140 may be used to analyze all of the costs associated with the long-term commitment between the contractor and sub-contractor and determine that it is better to meet the minimum threshold than handle the contacts internally with the resources 112. Therefore, the cost optimization agent 132 may instruct the work assignment engine 120 to switch routing algorithms 124a-N.

Accordingly, after the first amount of time (t1), the work assignment engine 120 begins applying a different routing algorithm 124 which causes a higher ratio of contacts to be provided to the sub-contractor (e.g., routed to the additional resources 148 rather than resources 112). After the routing algorithm 124 has been switched, the workload monitoring agent 128 may continue to monitor the workload provided to the sub-contractor and estimate whether the workload provided to the sub-contractor by the end of the commitment period (t3) is the optimal amount of workload. Specifically, the workload monitoring agent 128 may begin generating a second estimated workload curve and that second estimated workload curve may indicate that the number of contacts provided to the sub-contractor by the end of the commitment period (t3) exceeds the maximum threshold. This additional estimation information may be provided to the cost optimization agent 132, which again analyzes the estimation information for the commitment period (t3) and determines at a second time (t2) that the routing algorithm 124 should again be changed. Specifically, the cost optimization agent 128 may determine that costs associated with violating the long-term commitment 136 (e.g., contract costs such as penalties, fees, etc. associated with sending contacts in excess of the maximum) are greater than costs of handling the contacts internally with the resources 112. Accordingly, the cost optimization agent 132 may instruct the work assignment engine 120 to again switch routing algorithms 124. In some embodiments, the work assignment engine 120 may switch back to the original routing algorithm 124 (e.g., the routing algorithm being used prior to the first time (t1)). Alternatively, the work assignment engine 120 may switch to a third routing algorithm 124c which causes a lower ratio of contacts to be sent to the sub-contractor (e.g., routed to the additional resources 148) as compared to the routing algorithm that was used between times (t1) and (t2). The multiple adjustments of the routing algorithms may result in the work assignment mechanism 116 assigning an optimal number of contacts to the additional resources 148, which may be within the maximum and minimum thresholds defined by the long-term commitment between the contractor and sub-contractor.

FIG. 3C shows an example where a cost threshold over a commitment period (t2) is defined between a contractor and sub-contractor. The threshold in FIG. 3C may be a maximum amount of costs that can be spent on using a sub-contractor over a predetermined amount of time (t2). The predetermined amount of time may correspond to a commitment period if there is a contractual agreement between the contractor and sub-contractor or it may simply correspond to an amount of time (e.g., week, month, quarter, year) for which a cost budget has been set for using the sub-contractor's services. The maximum cost threshold may be related to workload either directly or indirectly or it may simply be a budget/dollar amount that has been set. The cost optimization agent 136 may only be tasked with ensuring that costs spent on the sub-contractor do not exceed the maximum threshold.

At the beginning of the period, no costs (e.g., in the form of costs for sending contacts to the sub-contractor or for failing to send enough contacts to the sub-contractor) have been incurred. After a first amount of time (t1) has passed, the workload monitoring agent 128 is capable of assessing the workload that has already been provided to the sub-contractor up to the first amount of time (t1). Similarly, the cost optimization agent 132 may be capable of equating the workload already provided to the sub-contractor to costs incurred for using the services of the sub-contractor. Based on this assessment, the workload monitoring agent 128 is configured to estimate the workload that will be provided to the sub-contractor by the end of the commitment period (t2). Likewise, the cost optimization agent 132 is capable of estimating costs that will be incurred for using the sub-contractor. Again, these costs may be computed based on any and all expenses provided to the sub-contractor (e.g., costs for sending contacts to the sub-contractor, costs for exceeding a contractual threshold, costs for failing to meet a contractual threshold, hard costs for having an agreement with the sub-contractor, administrative expenses, etc.). Specifically, the cost optimization agent 132 generates an estimated cost curve and determines that the estimated cost curve exceeds the maximum cost threshold prior to the end of the commitment period (t2). Based on this determination, the cost optimization agent 132 can instruct the work assignment engine 120 to change from a first routing algorithm 124a to a second routing algorithm 124b so to ensure that the cost threshold is not exceeded before the end of the commitment period (t2). By switching routing algorithms, the work assignment mechanism 116 is configured to maintain costs within the budget for the commitment period (t2).

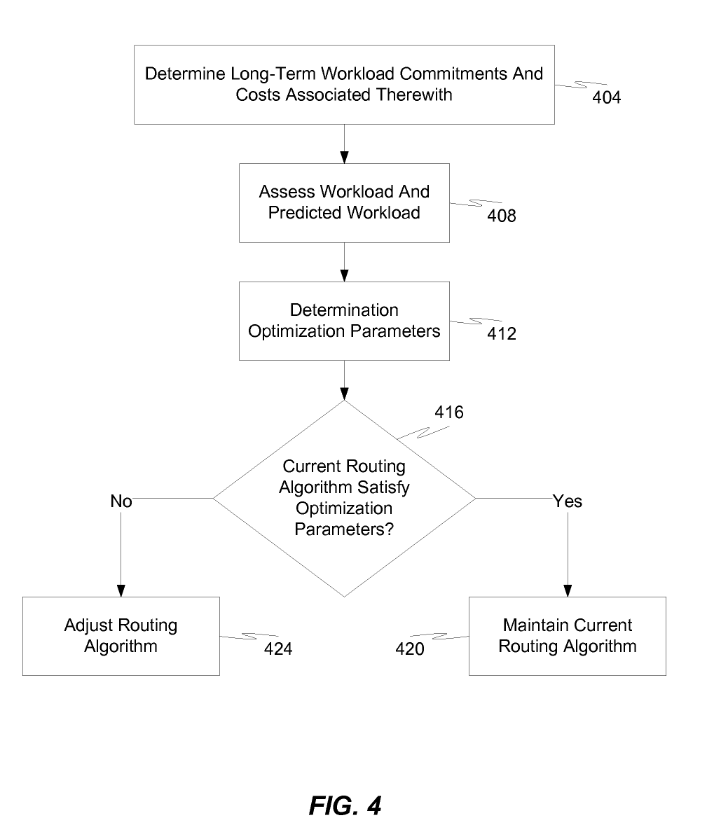

Referring now to FIG. 4, a flow diagram depicting a method of optimizing workloads/costs by adjusting work assignment algorithms in a contact center will be described in accordance with embodiments of the present disclosure. The method begins with the cost optimization agent 132 determining the long-term commitments 136 between a contractor (e.g., the entity operating the work assignment mechanism 116) and a sub-contractor (e.g., the entity operating the additional resources 148) (step 404). In this step, the cost optimization agent 132 may also determine the costs associated with the long-term commitments and any other possible expenses that may be incurred under the agreement between the contractor and sub-contractor. The cost optimization agent 132 may also determine any thresholds defined in the long-term commitments as those thresholds may relate to possible costs under the agreement.

The method continues with the workload monitoring agent 128 assessing the workload that has already been provided to the sub-contractor in the commitment period and further predicting workload that will be provided to the sub-contractor by the end of the commitment period (step 408). The estimations of the workload monitoring agent 128 may be determined by using any suitable estimation technique (e.g., trend analysis, linear regression, utilization of historical data from other commitment periods, historical modeling information, historical patterns adjusted for current events, estimation of work surpluses and shortages, combinations thereof, etc.). It should also be noted that other parameters may be used for optimization purposes such as profit analysis (instead of just cost analysis), customer satisfaction, employee satisfaction, etc.

The cost optimization agent 132 may then determine the optimization parameters, otherwise referred to as the rules for optimization (step 412). These parameters may be defined in the optimization algorithm 140 and may correspond to any single or set of business rules. For example, the optimization parameters may simply correspond to an optimization algorithm which attempts to minimize costs. Alternatively, the optimization parameters may correspond to a mixed optimization algorithm that tries to satisfy multiple optimization rules such as by minimizing costs, maximizing profit, and maximizing customer satisfaction (e.g., by minimizing wait time, minimizing call handle time, maximizing optimal match rate, etc.).

After the optimization parameters have been determined, the cost optimization agent 128 analyzes the current workload and estimated workload information provided from the workload monitoring agent and applies its optimization algorithm 140 to determine if the optimization parameters are currently being satisfied or if an alteration in the workload provided to the sub-contractor should be adjusted (step 416).

If the query in step 416 is answered affirmatively, then the cost optimization agent 132 will wait until additional estimation information is received from the workload monitoring agent 128, but will not immediately instruct the work assignment engine 120 to switch routing algorithms (step 420).

If, on the other hand, the query in step 416 is answered negatively, then the cost optimization agent 132 will instruct the work assignment engine 120 to switch routing algorithms from a first routing algorithm 124a to a second routing algorithm 124b (step 424). In this step, the cost optimization agent 132 may tell the work assignment engine 120 which routing algorithm should be used or it may simply tell the work assignment engine 120 about the need to adjust workload provided to the sub-contractor, thereby enabling the work assignment engine 120 to make its own determination as to which routing algorithm should be used. For example, the cost optimization agent 132 may simply instruct the work assignment engine 120 to reduce the ratio of contacts sent to the additional resources 148 and the work assignment engine 120 may select a routing algorithm 124 that causes fewer contacts to be routed to the additional resources 148.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A method of assisting routing behavior in a contact center that is operated by a first entity, the method comprising:
using, by a work assignment engine, a first routing algorithm to make work item routing decisions in the contact center, the first routing algorithm causing a first ratio or rate of work items to be routed to a second entity that operates additional resources outside the contact center;
assessing an agreement between the first entity and second entity that defines one or more long-term commitments over a commitment period;
estimating, at a first time during the commitment period, a total number of work items that will be routed to the second entity by the end of the commitment period; and
determining, by a cost optimization agent operating on a server in the contact center and based on the estimated total number of work items that will be routed to the second entity by the end of the commitment period, whether to continue using the first routing algorithm or to switch to using a second routing algorithm that causes a second ratio or rate of work items to be routed to the second entity.

2. The method of claim 1, further comprising:
determining, by the cost optimization agent, to switch from using the first routing algorithm to using the second routing algorithm; and
sending, from the cost optimization agent to the work assignment engine, an instruction to switch from the first routing algorithm to the second routing algorithm.

3. The method of claim 2, wherein the first ratio or rate of work items is greater than the second ratio or rate of work items.

4. The method of claim 1, wherein the one or more long-term commitments are also considered by the cost optimization agent when determining whether to continue using the first routing algorithm or to switch to using the second routing algorithm.

5. The method of claim 4, wherein the one or more long-term commitments include at least one of a minimum number of work items to be provided to the second entity by the end of the commitment period, a maximum number of work items to be provided to the second entity by the end of the commitment period, and a maximum cost to be incurred for routing work items to the second entity.

6. The method of claim 5, wherein the one or more long-term commitments comprises the minimum number of work items to be provided to the second entity by the end of the commitment period, wherein the estimated total number of work items is less than the minimum number of work items to be provided to the second entity by the end of the commitment period, wherein the cost optimization agent determines to switch to using the second routing algorithm, and wherein the second ratio or rate of work items is greater than the first ratio or rate of work items.

7. The method of claim 1, wherein the cost optimization agent employs one or more optimization algorithms in determining whether to continue using the first routing algorithm or to switch to using a second routing algorithm that causes a second ratio or rate of work items to be routed to the second entity and wherein the one or more optimization algorithms include at least one of a minimization function, a maximization function, and a near-to function.

8. The method of claim 7, wherein the cost optimization agent considers costs associated with sending work items to the second entity, costs associated with processing work items at the first entity, and costs associated with failing to provide a previously-agreed number of work items to the second entity by the end of the commitment period.

9. A non-transitory computer readable medium having stored thereon instructions that cause a computing system to execute a method, the instructions comprising:
instructions configured to employ a first routing algorithm to make work item routing decisions in a contact center operated by a first entity, the first routing algorithm causing a first ratio or rate of work items to be routed to a second entity that operates additional resources outside the contact center;
instructions configured to assess an agreement between the first entity and second entity that defines one or more long-term commitments over a commitment period;
instructions configured to estimate, at a first time during the commitment period, a total number of work items that will be routed to the second entity by the end of the commitment period; and
instructions configured to determine, based on the estimated total number of work items that will be routed to the second entity by the end of the commitment period, whether to continue employing the first routing algorithm or to switch to employing a second routing algorithm that causes a second ratio or rate of work items to be routed to the second entity.

10. The computer readable medium of claim 9, further comprising:
instructions configured to switch, during the commitment period, from employing the first routing algorithm to employing the second routing algorithm such thereby adjusting the ratio or rate of work items provided to the second entity after the first time.

11. The computer readable medium of claim 10, wherein the first ratio or rate of work items is greater than the second ratio or rate of work items.

12. The computer readable medium of claim 9, wherein the one or more long-term commitments are also considered by the instructions configured to determine whether to continue employing the first routing algorithm or to switch to employing the second routing algorithm.

13. The computer readable medium of claim 12, wherein the one or more long-term commitments include a maximum cost to be incurred for routing work items to the second entity, wherein the estimated total number of work items is less than the minimum number of work items to be provided to the second entity by the end of the commitment period, wherein the instructions configured to determine make the determination to switch to employing the second routing algorithm, and wherein the second ratio or rate of work items is less than the first ratio or rate of work items.

14. The computer readable medium of claim 9, wherein one or more optimization algorithms are employed by the instructions configured to determine whether to continue employing the first routing algorithm or to switch to employing a second routing algorithm that causes a second ratio or rate of work items to be routed to the second entity and wherein the one or more optimization algorithms include at least one of a minimization function, a maximization function, and a near-to function.

15. The computer readable medium of claim 14, wherein the instructions configured to determine are further configured to analyze costs associated with sending work items to the second entity, costs associated with processing work items at the first entity, and costs associated with failing to provide a previously-agreed number of work items to the second entity by the end of the commitment period.

16. A contact center operated by a first entity, the contact center comprising:
a work assignment mechanism including:
a work assignment engine configured to employ a plurality of different routing algorithms, each routing algorithm configured to enable the work assignment engine to make work assignment decisions in the contact center and each routing algorithm causing a different ratio or rate of work items to be routed to a second entity that operates additional resources outside the contact center;
a workload monitoring agent configured to estimate, during a commitment period defined by an agreement between the first and second entity, a total number of work items that will be routed from the first entity to the second entity by the end of the commitment period; and
a cost optimization agent configured to receive as an input the estimated total number of work items that will be routed to the second entity by the end of the commitment period and based on the received input determine whether to continue using the first routing algorithm or to switch to using a second routing algorithm that causes a second ratio or rate of work items to be routed to the second entity.

17. The contact center of claim 16, further comprising:
a routing engine configured to receiving routing instructions from the work assignment mechanism and route work items to both resources that are within the contact center and the additional resources that are operated by the second entity.

18. The contact center of claim 16, wherein one or more long-term commitments identified in the agreement are also considered by the cost optimization agent when determining whether to continue using the first routing algorithm or to switch to using the second routing algorithm.

19. The contact center of claim 18, wherein the one or more long-term commitments include at least one of a minimum number of work items to be provided to the second entity by the end of the commitment period, a maximum number of work items to be provided to the second entity by the end of the commitment period, and a maximum cost to be incurred for routing work items to the second entity.

20. The contact center of claim 16, wherein the additional resources are separated from the work assignment mechanism and resources in the contact center by a trans-oceanic communication network.
